(19) United States
(12) Patent Application Publication
(10) Pub. No.: US 2024/0359306 A1
(43) Pub. Date: Oct. 31, 2024

(54) SCRENCH HOLDERS AND TOOLS HAVING SCRENCH HOLDERS

(71) Applicant: Milwaukee Electric Tool Corporation, Brookfield, WI (US)

(72) Inventors: Jordan Smith, Brookfield, WI (US); Alison Wilhelm, Brookfield, WI (US)

(21) Appl. No.: 18/645,440

(22) Filed: Apr. 25, 2024

Related U.S. Application Data
(60) Provisional application No. 63/543,365, filed on Oct. 10, 2023.
(60) Provisional application No. 63/461,716, filed on Apr. 25, 2023.

(51) Int. Cl. B25F 5/02; B25B 13/48; B25F 1/00; B27B 17/00

(52) U.S. Cl. CPC B25F 5/029; B25B 13/48; B27B 17/0008; B25F 1/00

(57) ABSTRACT

A power tool includes an electric motor operably coupled to a work element; a terminal configured to interface with a battery to provide power from the battery to the electric motor to drive the work element; a scrench holder, and a scrench, wherein the scrench is detachable from the scrench holder when the battery is detached from the terminal, and wherein the scrench is inaccessible when the battery is coupled to the terminal.

### CROSS-REFERENCE TO RELATED APPLICATIONS

This application is a non-provisional application claiming the benefit of priority under 35 U.S.C. § 119 (e) to U.S. Provisional Application No. 63/461,716, filed on Apr. 25, 2023, and U.S. Provisional Application No. 63/543,365, filed Oct. 10, 2023, which are hereby incorporated by reference in their entirety.

### FIELD

The present disclosure relates generally to scrench holders and tools having scrench holders.

### BACKGROUND

Power tools require ongoing adjustment and maintenance during use. One tool that is utilized on several types of power tools to perform adjustment and maintenance is a scrench. Screnches typically include multiple types of tools combined into a single unit. The tools permit more convenient tool adjustment and maintenance by providing the operator with multiple functional tools in a single construction.

A traditional scrench includes a screwdriver and one or more wrench sockets. The screwdriver includes a body which is typically straight to define a longitudinal axis terminating at opposite terminal and distal ends. The wrench socket is typically disposed at or adjacent to one of the terminal or distal ends of the screwdriver. When using the wrench sockets, the screwdriver body acts as a handle, permitting leverage on the wrench socket.

There are several known ways to store screnches. A first option is to store the scrench separate from the power tool. This may be performed using a utility belt, a belt holder, a pocket, a tool chest or cabinet, a work bag, another tool storage apparatus, or by simply laying the scrench on the ground at a jobsite. A second option is to store the scrench on the tool. However, on-tool storage presents several issues. First, the scrench may come loose from the tool and fall during use. It may be difficult for the operator to find the scrench. Second, the scrench may be inconveniently placed at a location that interferes with operation of the tool. Third, the scrench may be stored at a location where an end of the scrench extends past one or more outer dimensions of the tool making tool storage inconvenient.

Accordingly, improved scrench holders and tools having improved scrench holders are desired in the art. In particular, scrench holders and power tools having scrench holders which provide convenient storage of screnches would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a power tool is provided. The power tool includes an electric motor operably coupled to a work element; a terminal configured to interface with a battery to provide power from the battery to the electric motor to drive the work element; a scrench holder; and a scrench, wherein the scrench is detachable from the scrench holder when the battery is detached from the terminal, and wherein the scrench is inaccessible when the battery is coupled to the terminal.

In accordance with another embodiment, a power tool is provided. The power tool includes a battery; a scrench; and a scrench holder, wherein the scrench is removable from the scrench holder when the battery is detached from the power tool, and wherein the scrench is inaccessible when the battery is coupled to the power tool.

In accordance with another embodiment, a method of using a scrench on a power tool is provided. The method includes removing a battery from a terminal of the power tool; and removing the scrench from a scrench holder while the battery is removed from the power tool, wherein access to the scrench is prevented prior to removing the battery from the terminal.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective tool of a pole saw in accordance with embodiments of the present disclosure;

FIG. 2 is a rear perspective view of a portion of a pole saw including a scrench coupled to a scrench holder of the pole saw in accordance with embodiments of the present disclosure;

FIG. 3 is a side view of a portion of the pole saw in accordance with embodiments of the present disclosure;

FIG. 4 is a top view of a portion of the pole saw in accordance with embodiments of the present disclosure; and

FIG. 5 is a side perspective view of a component of a guard of the pole saw in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive—or and not to an exclusive—or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Power tools described herein generally include scrench holders that store a scrench when use of the scrench is not required. When stored, it is undesirable for the scrench to detach from the power tool. If the scrench detaches from the power tool during use of the tool, it may become lost or damaged. To prevent accidental detachment of the scrench from the power tool, the scrench holder can be disposed at a location that is selectively inaccessible when the power tool, or one or more components thereof, is moved to a scrench-inaccessible position. Conversely, the location of the scrench holder may be accessed when the power tool, or the one or more components thereof, is moved to a scrench-accessible position.

In an embodiment, the power tool is an electric power tool including one or more batteries that provide electrical power to drive a work element of the power tool, e.g., a powered saw. At least one of the batteries can form an interference with the scrench holder to selectively prevent removal of the scrench from the scrench holder when the battery is coupled to the power tool. When the battery is detached from the power tool, the scrench may be accessible. Thus, the operator can gain access to the scrench by removing the battery from the power tool. Conversely, the operator can mitigate access to the scrench, and prevent accidental detachment of the scrench from the power tool, by attaching the battery to the power tool.

Removing the battery before access to the scrench is possible disallows use of the power tool while the operator performs a screnching operation. That is, access to the scrench requires removal of the battery from the power tool. By removing the battery to access the scrench, the power tool is rendered inactive. Since returning the scrench to the scrench holder requires removal of the battery, it is believed that operators will perform operations on the power tool using the scrench with the battery removed, and thus the power tool inactive. In this regard, the power tool cannot be activated during screnching operations and the operator is safer to work around dangerous work elements, such as toothed chains, moving blades, spinning trimmer string, reciprocating blades, or the like.

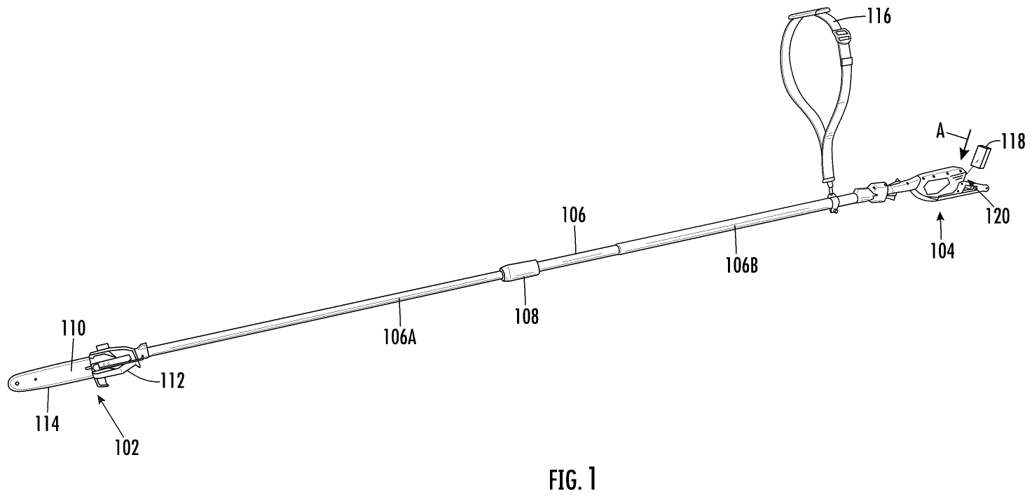

Referring now to the drawings, FIG. 1 illustrates a power tool in accordance with an exemplary embodiment. The depicted power tool is a pole saw 100. The pole saw 100 generally includes a work element 102, a body 104, and a pole 106 extending between and connecting together the work element 102 and the body 104. In an embodiment, the pole 106 is adjustable in length. For example, the pole 106 can be telescopic, including one or more segments 106A and 106B that telescopically move relative to one another. The operator can adjust a distance between the work element 102 and the body 104 by adjusting the relative positions of the segments 106A and 106B with respect to one another. A lock 108 can be used to maintain the segments 106A and 106B at relatively fixed positions with respect to one another.

The work element 102 of the pole saw 100 is a sawing tool configured to cut material. The sawing tool includes a bar 110 extending from a work element housing 112. A chain 114 extends in an infinite loop around the bar 110 and is driven to move within a track of the bar 110. Holding the pole saw 100 at the body 104 and pole 106, an operator can maneuver the sawing tool into position nearby an object, such as a branch, and urge the chain 114 into the object with the chain 114 in motion to cut the object. The operator can repeat this process as necessary. An optional shoulder or body strap 116 can be used for prolonged use of the pole saw 100 to mitigate fatigue.

The chain 114 is driven by a motor (not illustrated). In one embodiment, the motor is housed within the body 104. A driveshaft can extend through the pole 106 to transfer power from the motor to the chain 114 through a chain sprocket. In another embodiment, the motor can be housed within the work element housing 112 and drive the chain 114 through a chain sprocket.

By way of non-limiting example, the motor can be an electric motor, such as a direct current (DC) brushless motor. The motor includes an output shaft rotatably pinned to the chain sprocket, e.g., through a driveshaft. As the output shaft rotates, the chain 114 is driven within the track of the bar 110. In an embodiment, the motor receives electrical power from one or more batteries 116.

As depicted in FIG. 1, the pole saw 100 can include a receiving area 120 configured to receive a single battery 116. However, in other embodiments, the receiving area 120 can receive a plurality of batteries 116, such as at least two batteries, at least three batteries, or even at least four batteries. In an embodiment, the battery or batteries 116 can be installed in the receiving area 120 through a translational motion oriented in a direction shown by arrow A. In another embodiment, the battery or batteries 116 can be installed in the receiving area 120 through a translational motion oriented in another direction, in a rotational motion, or in a translational-rotational motion.

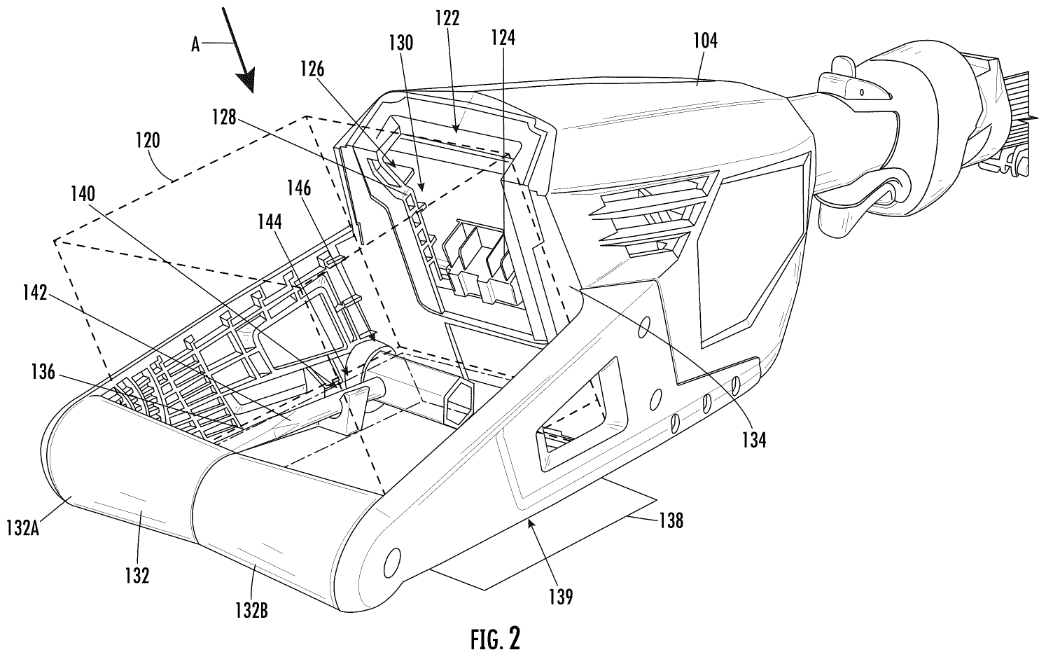

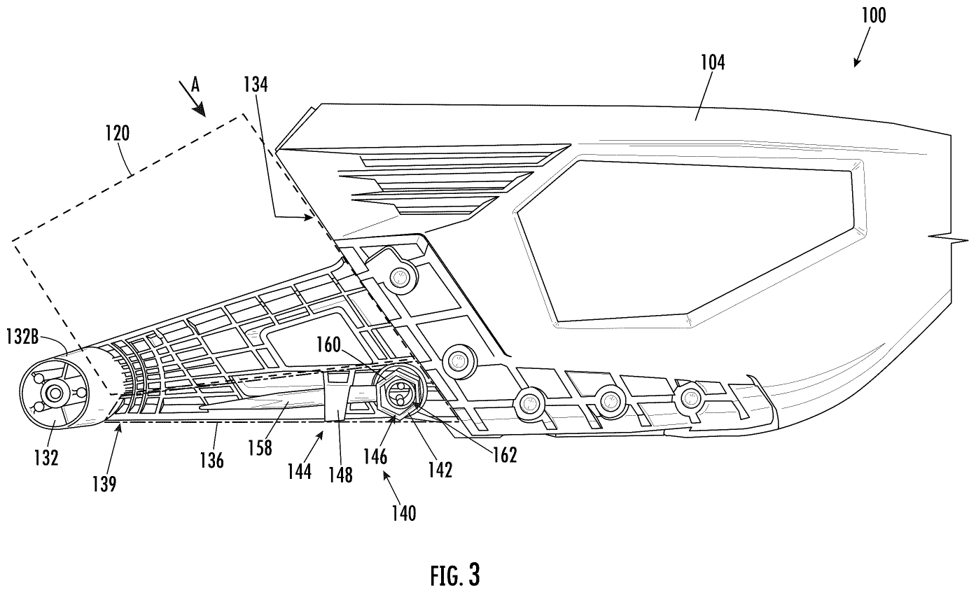

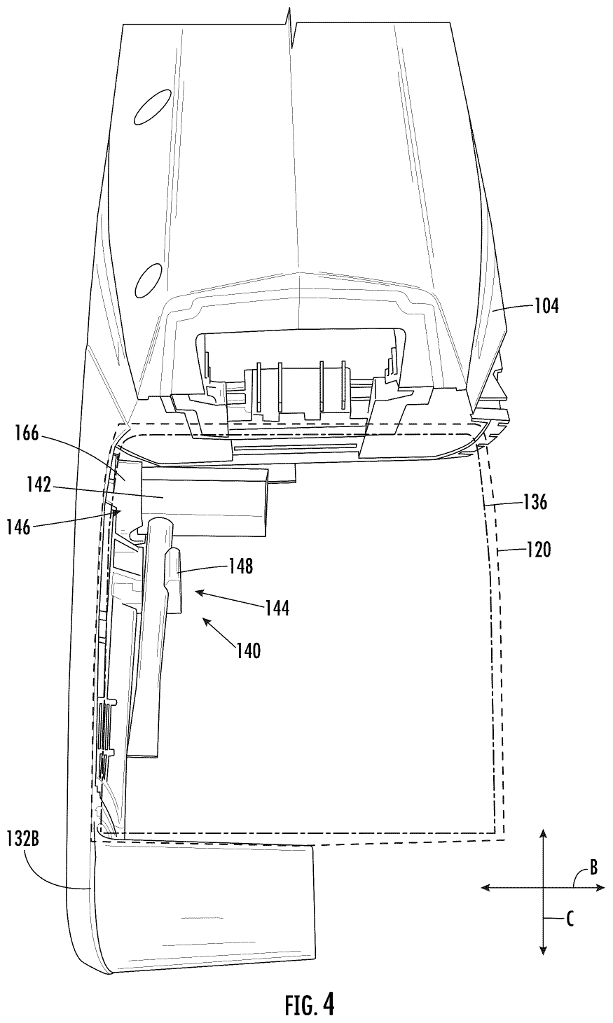

FIG. 2 illustrates a portion of the pole saw 100 with the receiving area 120 shown bounded by a dashed outline. FIG. 3 illustrates a portion of the pole saw 100 with the receiving area 120 as seen from a side view. FIG. 4 illustrates a portion of the pole saw 100 with the receiving area 120 as seen from a top view.

The shape and size of the receiving area 120 is generally defined by the shape and size of the battery or batteries 116 received in the receiving area 120. It should be understood that the entire receiving area 120 may not be physically demarcated by the pole saw 100. Instead, the receiving area 120 can refer to a volumetric region of the pole saw 100 in which the battery or batteries 116 are disposed when coupled to the pole saw 100. In some instances, the receiving area 120 can further include a volume through which the battery or batteries 116 pass when installed on the pole saw 100. The body 104 (and optionally other components of the pole saw 100) may be shaped and sized such that the receiving area 120 is a close fit in size and shape to the battery or batteries 116 installed in the receiving area 120. Pole saws 100 receiving differently shaped and sized batteries 116 may define differently shaped and sized receiving areas 120.

Referring to FIGS. 2 and 3, the receiving area 120 can be disposed adjacent to a terminal 122 of the pole saw 100. The terminal 122 is configured to interface with the battery 116 and provide power from the battery 116 to an electrical power system of the pole saw 100 that drives the motor. The terminal 122 can include electrical contacts 124 that mate with corresponding electrical contacts of the battery 116 to complete an electrical circuit between the battery 116 and the electrical power system of the pole saw 100. The terminal 122 can further include an engagement structure 126 configured to mechanically couple the battery 116 to the pole saw 100. The engagement structure 126 can include one or more guides 128 each defining a slot 130. The battery 116 can include complementary features, such as rails (not illustrated) that slide within the slots 130 to interface the electrical contacts of the battery 116 with the electrical contacts 124 of the terminal 122. The battery 116 can translate into the receiving area 120 from a first position, along the guides 128 in a direction shown by arrow A until the battery 116 is electrically coupled to the terminal 122 in a second position within the receiving area 120.

In an embodiment, the pole saw 100 includes a protective feature that extends around at least a portion of the battery receiving area 120 to protect the battery from damage such as caused by impact with an object during use or a drop from the in-use position. The protective feature can include a guard 132. The guard 132 can be coupled to the body 104 and extend from a rear end 134 of the body 104 in a rearward direction. In an embodiment, the guard 132 can define a rearmost end of the pole saw 100. In an embodiment, the guard 132 can be formed from two discrete components 132A and 132B coupled together. By way of example, the two components 132A and 132B can each extend from the body 104 and meet at a midline of the pole saw 100. The two components 132A and 132B can each be coupled to the body 104 and be coupled together by a fastener (not illustrated). In some instances, the two components 132A and 132B can be reflectively symmetrical about the midline of the pole saw 100, or substantially reflectively symmetrical about the midline of the pole saw 100.

As depicted in FIGS. 2 and 3, the pole saw 100 can define a second receiving area 136. In an embodiment, the second receiving area 136 can be bounded by the receiving area 120, the guard 132, and a best fit plane 138 defined by a surface 139 of the guard 132 opposite the receiving area 120. The second receiving area 136 can be disposed immediately adjacent to the receiving area 120. More particularly, the second receiving area 136 can be disposed below the receiving area 120 when the pole saw 100 is oriented in a typical in-use orientation (e.g., as seen in FIG. 3). In some instances, the portion of the pole saw 100 represented by the best fit plane 138 can be open, i.e., include an aperture through which the receiving area 120 or second receiving area 136 can be accessed (e.g., as illustrated in FIGS. 2 and 3). In other instances, the portion of the pole saw 100 represented by the best fit plate 138 can be closed, e.g., be formed by the guard 132. That is, for example, the surface 139 of the guard 132 can extend continuously and close the bottom of the second receiving area 136. It should be understood that the second receiving area 136 may not be physically demarcated by the pole saw 100. Instead, the second receiving area 136 can refer to a volumetric region of the pole saw 100 including one or more features for scrench retention as described in greater detail below.

The second receiving area 136 can include a scrench holder 140 that selectively receives a scrench 142. The scrench 142 can be at least partially disposed within the second receiving area 136 when the scrench 142 is coupled with the scrench holder 140. In an embodiment, the entire scrench 142 can be disposed in the second receiving area 136 when the scrench 142 is coupled with the scrench holder 140. As the scrench 142 an define one or more sharp edges, disposal of the entire scrench 142 in a region where an operator is prevented from accidently contacting the scrench 142, such as in the second receiving area 136, may be desirable.

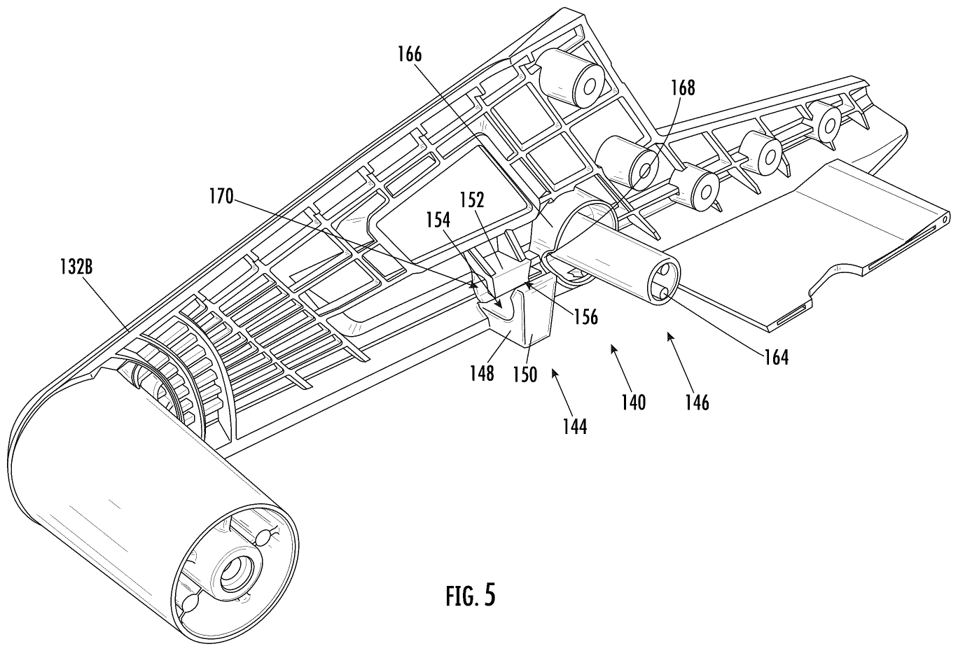

FIG. 5 illustrates a perspective view of the second of the two components 132B as seen in accordance with an embodiment. Referring to FIGS. 2 to 5, the scrench holder 140 can define one or more scrench interfacing areas, such as a first scrench interfacing area 144 and a second scrench interfacing area 146. Each of the scrench interfacing areas can interface with the scrench 142 to retain the scrench 142 in a stored position on the pole saw 100. Each of the different scrench interfacing areas may retain the scrench 142 against different forces or force directions as compared to one another. For instance, by way of non-limiting example, the first scrench interfacing area 144 can retain the scrench 142 at a relatively fixed position relative to the pole saw 100 in a first direction as shown by arrow B and the second scrench interfacing area 146 can retain the scrench 142 at a relatively fixed position relative to the pole saw 100 in a second direction as shown by arrow C (see, e.g., FIG. 4). Together, the first and second scrench interfacing areas 144 and 146 can retain the scrench 142 at a relatively fixed position relative to the pole saw 100 in a third direction perpendicular to the first and second directions (e.g., out of the page in FIG. 4). Together, the first and second scrench interfacing areas 144 and 146 can maintain the scrench 142 at a relatively fixed position with respect to the second receiving area 136 in each orthogonal direction. In yet other embodiments, the one or more scrench interfacing areas can further include a third scrench interfacing area, a fourth scrench interfacing area, a fifth scrench interfacing area, etc. In some instances, the scrench holder 140, or a portion of the scrench holder 140, can be integral with, i.e., formed from a single piece with, the guard 132 or another portion of the pole saw 100. In other embodiments, the scrench holder 140 can include a discrete, i.e., separate, component coupled to the guard 132 or another portion of the pole saw 100. Exemplary scrench interfacing areas are described below. However, the present disclosure is not intended to be limited to the described scrench interfacing areas or the described configuration of scrench interfacing areas.

Screnches 142 often include two distinct tools combined into one—a screwdriver 158 and a socket wrench 160 (see, e.g., FIG. 3). The screwdriver 158 forms an elongated shaft that can be receivable at the first scrench interfacing area 144. The socket wrench 160 includes an opening 162 that can be receivable at the second scrench interfacing area 146.

In an embodiment, the first scrench interfacing area 144 can include an arm 148 extending from the guard 132 into the second receiving area 136. In an embodiment, the arm 148 extends in a direction generally perpendicular to a sidewall of the guard 132. The arm 148 can include a distal aspect, such as a distal flange 150. The first scrench interfacing area 144 can further include a proximal aspect, such as a proximal flange 152. In an embodiment, the proximal flange 152 can extend directly from the sidewall of the guard 132. In another embodiment, the proximal flange 152 can extend from the arm 148. The distal and proximal flanges 150 and 152 can define a scrench receiving area 154 in which a portion of the scrench 142 can be disposed when the scrench 142 is coupled to the first scrench interfacing area 144. In an embodiment, the scrench receiving area 154 can define a dimension greater than a dimension of an entrance 156 into the scrench receiving area 154. The scrench can translate through the entrance 156 to reach the scrench receiving area 154. When the scrench 142 is being moved into the scrench receiving area 154, the arm 148 deflects to permit passage of the scrench 142 through the entrance 156 and into the scrench receiving area 154. Once the scrench 142 passes by the entrance 156, the arm 148 rebounds to its undeflected (i.e., natural) state. In its undeflected state, the arm 148 prevents unwanted removal of the scrench 142 from the scrench receiving area 154. To remove the scrench 142 from the scrench receiving area 154, an operator can apply force to the scrench 142, causing the scrench 142 to bias into the arm 148, causing the arm 1489 to deflect and allowing passage of the scrench 142 through the entrance 156.

In an embodiment, the second scrench interfacing area 146 includes a guide 164 onto which the socket wrench 160 fits. The guide 164 can extend into or through the opening 162 in the socket wrench 160. The guide 164 can define an outer dimension, e.g., a diameter, smaller than an inner diameter of the opening 162 of the socket wrench 160. The guide 164 can extend from the guard 132 into the second receiving area 136. To install the scrench 142 at the second scrench interfacing area 146, the operator moves the scrench 142 into the second receiving area 136, aligns the opening 162 of the socket wrench 160 with the guide 164 and laterally translates the socket wrench 160 in a direction associated with arrowed line B in FIG. 4. The operator can continue translating the socket wrench 160 until the scrench 142 contacts the guide 132 or otherwise is prevented from translating in the direction associated with the arrowed line B. Once translated at least partially along the guide 164, the socket wrench 160 is retained by the guide 164 in all directions except the direction associated with the arrowed line B in FIG. 4.

The second scrench interfacing area 146 can further include a secondary retention feature such as a wall 166 extending around at least a portion of the guide 164. The wall 166 can define an inner dimension, e.g., a diameter, that is larger than an outer diameter of the socket wrench 160. When installing the scrench 142 in the scrench holder 140 by translating the socket wrench 160 in the direction associated with the arrowed line B in FIG. 4, the socket wrench 160 moves to a position within the wall 166 and becomes captured by the wall 166 such that movement in a radial direction relative to the guide 164 is prevented by the wall 166. Once captured by the wall 166, the socket wrench 160 is retained by the wall 166 in all directions except the direction associated with the arrowed line B in FIG. 4. The guide 164 and wall 166 can individually or together prevent removal of the scrench 142 from the second scrench interfacing area 146 in a direction shown by arrow C (FIG. 4).

In an embodiment, installation of the scrench 142 at the scrench holder 140 can require a specific pattern of steps. The specific pattern of steps can be performed by a combination of rotational and translational movement. For instance, in some embodiments, the scrench 142 is first installed at the second scrench interfacing area 146. The opening 162 of the socket wrench 160 can be aligned relative to the guide 164 and then translated along the guide 164. With the scrench 142 at least partially coupled to the second scrench interfacing area 146, the scrench 142 can then be coupled to the first scrench interfacing area 144. This can be performed by rotating the scrench 142 about the guide 164 until the elongated shaft of the scrench 142 is captured by the scrench receiving area 154 of the first scrench interfacing area 144. In some instances, the scrench 142 is stored in this position with the elongated shaft captured in the scrench receiving area 154. In other instances, the scrench 142 can be further translated in the direction associated with arrowed line B in FIG. 4 to arrive at a final stored position. The wall 166 of the second scrench interfacing area 146 can define a cutout 168 through which the elongated shaft of the scrench 142 can extend. The cutout 168 can be aligned with a storage area 170 of the first scrench interfacing area 144 in open communication with the scrench receiving area 154. By further translating the scrench 142 to the final stored position, the elongated shaft is disposed at least partially within the cutout 168 and the storage area 170. Removal of the scrench 142 from the scrench holder 140 can be performed using the same steps as described above in reverse. For example, the scrench 142 can be removed from the scrench holder 140 by first translating the scrench 142 from the storage area 170 towards the distal flange 150, then rotating the scrench 142 about the guide 164 until the elongated shaft is clear of the distal flange 150, and finally translating the scrench 142 in a direction along the guide 164 away from the wall 166 until the scrench 142 is clear of the guide 164.

Referring again to the embodiment depicted in FIG. 2, rotating the scrench 142 about the guide 164 (FIG. 5) to remove the scrench 142 from the scrench holder 140 is prohibited when the battery 116 is disposed in the receiving area 120. With the battery 116 in the receiving area 120, any rotation of the scrench 142 is met by contact of the scrench 142 with an outer perimeter surface of the battery 116. Without rotation of the scrench 142 about the guide 164, removal of the scrench 142 from the scrench holder 140 is not possible. Removing the scrench 142 from the scrench holder 140 thus requires removing the battery 116 from the receiving area 120 prior to removing the scrench 142. In another embodiment, the scrench holder 140 or battery 116 can be oriented in a different direction such that translation of the scrench 142 along the guide 164 (FIG. 5) to remove the scrench from the scrench holder 140 is prohibited when the battery 116 is disposed in the receiving area 120. That is, the step associated with removal of the scrench 142 prohibiting accidental detachment of the scrench 142 from the scrench holder 140 can be translational rather than rotational. Yet alternatively, the step preventing accidental detachment of the scrench 142 can include both translational and rotational movement. That is, the scrench 142 may not be translatable or rotatable due to the relative placement of the battery 116, or another object of the pole saw 100, when installed in the receiving area 120.

Without wishing to be bound by any particular theory, it is believed that requiring removal of the battery 116 from the receiving area 120, i.e., disabling the pole saw 100, prior to accessing the scrench 142 reduces the likelihood of an operator accidently engaging the work element 102 (e.g., saw blades) when actively performing a screnching operation using the scrench 142 at the work element 102. In such a manner, the operator is less likely to work on an active tool which might harm the operator if, for example, the work element is accidently triggered or if the tool malfunctions. In some instances, the pole saw 100 may be deactivated by removal of the scrench 142 from the scrench holder 140 such that the operator must return the scrench 142 to the scrench holder 140 to use the pole saw 100. For example, the scrench holder 140 can include a contact kill switch that disables the motor when the contact kill switch detects the absence of the scrench 142. Thus, regardless of whether the battery 116 is installed in the receiving area 120, the operator cannot utilize the pole saw 100 without the scrench 142 in the stored position. When installed, the battery 116 effectively prevents the scrench 142 from accidently or undesirably detaching from the scrench holder 140, and thus reduces the likelihood of losing the scrench 142 as may occur when holding a scrench using a utility belt, a belt holder, a pocket, a tool chest or cabinet, a work bag, another tool storage apparatus, or by simply laying the scrench on the ground at a jobsite.

While prevented from detaching while the battery 116 is in the receiving area 120, the scrench 142 can remain visible to the operator from at least one vantage point external to the pole saw 100. That is, the operator may be able to inspect the power tool 100 to determine if the scrench 142 is present even when the scrench 142 is not accessible, i.e., when the battery 116 is disposed in the receiving area 120. If the scrench 142 is present and use of the scrench 142 is desired, the operator can then remove the battery 116 from the receiving area 120 to access the scrench 142.

While embodiments herein are specifically described with respect to pole saws, it should be understood that other power tools may include the scrench holder 140 in accordance with one or more embodiments described herein. For example, the scrench holder 140 can be utilized with chainsaws, minisaws, powered loppers, powered pruners, lawn maintenance tools, and the like. Moreover, while embodiments described herein utilize scrench holders 140 disposed at a particular location with respect to the pole saw 100, i.e., selectively covered by the receiving area 120, in other embodiments the scrench 142 may be selectively accessible and covered by another element of the power tool. That is, the scrench 142 may be rendered inaccessible by an object or portion of the pole saw or power tool other than the battery. Yet further, the scrench 142 can be coupled to another area of the power tool or even swappable between a plurality of different storage locations disposed along the power tool.

Further aspects of the invention are provided by one or more of the following embodiments:

Embodiment 1. A power tool comprising: an electric motor operably coupled to a work element; a terminal configured to interface with a battery to provide power from the battery to the electric motor to drive the work element; a scrench holder; and a scrench, wherein the scrench is detachable from the scrench holder when the battery is detached from the terminal, and wherein the scrench is inaccessible when the battery is coupled to the terminal.

Embodiment 2. The power tool of embodiment 1, wherein the power tool defines a receiving area to receive the battery, and wherein the power tool comprises a guard disposed around the receiving area to protect the battery from impact, and wherein the scrench holder is coupled to the guard.

Embodiment 3. The power tool of embodiment 2, wherein at least a portion of the scrench is disposed between the guard and the battery when the battery is coupled to the terminal.

Embodiment 4. The power tool of any one of embodiments 2 or 3, wherein receiving area has a shape configured to accommodate a shape of the battery, wherein the guard defines a secondary receiving area accommodating the scrench holder, and wherein the second receiving area is disposed immediately adjacent to the receiving area.

Embodiment 5. The power tool of any one of the preceding embodiments, wherein installation and removal of the scrench from the scrench holder is performed using a specific pattern of steps.

Embodiment 6. The power tool of any one of the preceding embodiments, wherein the scrench is installed at the scrench holder by translating the scrench in a first direction along a guide, and then rotating the scrench about the guide until the scrench is coupled with a scrench receiving area.

Embodiment 7. The power tool of any one of the preceding embodiments, wherein the scrench holder comprises a flange to retain the scrench in the scrench holder, and wherein the flange is configured to deflect when the scrench is introduced to the scrench holder and removed from the scrench holder.

Embodiment 8. The power tool of any one of the preceding embodiments, wherein the power tool comprises: a body; and a pole extending between the body and the work element, wherein the scrench holder is disposed on a rear side of the body.

Embodiment 9. A power tool comprising: a battery; a scrench; and a scrench holder, wherein the scrench is removable from the scrench holder when the battery is detached from the power tool, and wherein the scrench is inaccessible when the battery is coupled to the power tool.

Embodiment 10. The power tool of embodiment 9, wherein the power tool further comprises: a terminal configured to receive the battery; and a guard disposed around the terminal to protect the battery, wherein the scrench holder is coupled to the guard, wherein removal of the scrench from the scrench holder is performed at least in part by rotating the scrench, and wherein rotation of the scrench is prevented by the battery when the battery is coupled to the terminal.

Embodiment 11. The power tool of embodiment 10, wherein the scrench holder and at least part of the guard are formed from a single piece.

Embodiment 12. The power tool of any one of embodiments 9-11, wherein the power tool comprises: a body; and a pole extending between the body and the work element, wherein the scrench holder is disposed on a rear side of the body.

Embodiment 13. The power tool of any one of embodiments 9-12, wherein the battery is removable from the power tool through translation in a first direction, wherein the scrench is removable from the scrench holder through translation in a second direction, and wherein the first and second directions are different from one another.

Embodiment 14. A method of using a scrench on a power tool, the method comprising: removing a battery from a terminal of the power tool; and removing the scrench from a scrench holder while the battery is removed from the power tool, wherein access to the scrench is prevented prior to removing the battery from the terminal.

Embodiment 15. The method of embodiment 14, wherein removing the scrench from the scrench holder is performed by rotating the scrench about an axis and then translating the scrench along the axis.

Embodiment 16. The method of embodiment 15, wherein rotation of the scrench about the axis is prevented prior to removing the battery from the power tool.

Embodiment 17. The method of any one of embodiments 14 or 15, wherein translating the scrench along the axis is prevented prior to removing the battery from the power tool.

Embodiment 18. The method of any one of embodiments 14-17, wherein after using the scrench, the method further comprises: recoupling the scrench to the scrench holder; and recoupling the battery to the terminal after the scrench is recoupled to the scrench holder, wherein access to the scrench is prevented after recoupling the battery to the terminal.

Embodiment 19. The method of any one of embodiments 14-18, wherein the scrench holder comprises a first scrench interfacing area including a flange to retain the scrench at the first scrench interfacing area, and wherein removing the scrench from the first scrench interfacing area causes the flange to deflect to permit passage of the scrench from the first scrench interfacing area.

Embodiment 20. The method of any one of embodiments 14-19, wherein the scrench is visible prior to removing the battery from the terminal.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A power tool comprising:
an electric motor operably coupled to a work element;
a terminal configured to interface with a battery to provide power from the battery to the electric motor to drive the work element;
a scrench holder; and
a scrench,
wherein the scrench is detachable from the scrench holder when the battery is detached from the terminal, and
wherein the scrench is inaccessible when the battery is coupled to the terminal.

2. The power tool of claim 1, wherein the power tool defines a receiving area to receive the battery, and wherein the power tool comprises a guard disposed around the receiving area to protect the battery from impact, and wherein the scrench holder is coupled to the guard.

3. The power tool of claim 2, wherein at least a portion of the scrench is disposed between the guard and the battery when the battery is coupled to the terminal.

4. The power tool of claim 2, wherein receiving area has a shape configured to accommodate a shape of the battery, wherein the guard defines a secondary receiving area accommodating the scrench holder, and wherein the second receiving area is disposed immediately adjacent to the receiving area.

5. The power tool of claim 1, wherein installation and removal of the scrench from the scrench holder is performed using a specific pattern of steps.

6. The power tool of claim 1, wherein the scrench is installed at the scrench holder by translating the scrench in a first direction along a guide, and then rotating the scrench about the guide until the scrench is coupled with a scrench receiving area.

7. The power tool of claim 1, wherein the scrench holder comprises a flange to retain the scrench in the scrench holder, and wherein the flange is configured to deflect when the scrench is introduced to the scrench holder and removed from the scrench holder.

8. The power tool of claim 1, wherein the power tool comprises:
a body; and
a pole extending between the body and the work element,
wherein the scrench holder is disposed on a rear side of the body.

9. A power tool comprising:
a battery;
a scrench; and
a scrench holder,
wherein the scrench is removable from the scrench holder when the battery is detached from the power tool, and wherein the scrench is inaccessible when the battery is coupled to the power tool.

10. The power tool of claim 9, wherein the power tool further comprises:
a terminal configured to receive the battery; and
a guard disposed around the terminal to protect the battery,
wherein the scrench holder is coupled to the guard,
wherein removal of the scrench from the scrench holder is performed at least in part by rotating the scrench, and
wherein rotation of the scrench is prevented by the battery when the battery is coupled to the terminal.

11. The power tool of claim 10, wherein the scrench holder and at least part of the guard are formed from a single piece.

12. The power tool of claim 9, wherein the power tool comprises:
a body; and
a pole extending between the body and a work element,
wherein the scrench holder is disposed on a rear side of the body.

13. The power tool of claim 9, wherein the battery is removable from the power tool through translation in a first direction, wherein the scrench is removable from the scrench holder through translation in a second direction, and wherein the first and second directions are different from one another.

14. A method of using a scrench on a power tool, the method comprising:
removing a battery from a terminal of the power tool; and
removing the scrench from a scrench holder while the battery is removed from the power tool,
wherein access to the scrench is prevented prior to removing the battery from the terminal.

15. The method of claim 14, wherein removing the scrench from the scrench holder is performed by rotating the scrench about an axis and then translating the scrench along the axis.

16. The method of claim 15, wherein rotation of the scrench about the axis is prevented prior to removing the battery from the power tool.

17. The method of claim 15, wherein translating the scrench along the axis is prevented prior to removing the battery from the power tool.

18. The method of claim 14, wherein after using the scrench, the method further comprises:
recoupling the scrench to the scrench holder; and
recoupling the battery to the terminal after the scrench is recoupled to the scrench holder,
wherein access to the scrench is prevented after recoupling the battery to the terminal.

19. The method of claim 14, wherein the scrench holder comprises a first scrench interfacing area including a flange to retain the scrench at the first scrench interfacing area, and wherein removing the scrench from the first scrench interfacing area causes the flange to deflect to permit passage of the scrench from the first scrench interfacing area.

20. The method of claim 14, wherein the scrench is visible prior to removing the battery from the terminal.
